(19) United States
(12) Patent Application Publication
(10) Pub. No.: US 2023/0020497 A1
(43) Pub. Date: Jan. 19, 2023

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Katsuya KOBAYASHI, Okazaki-shi (JP); Takahiro HIRANO, Gotemba-shi (JP); Midori SUGIYAMA, Susono-shi (JP); Ryunosuke YAMASHITA, Susono-shi (JP)

(21) Appl. No.: 17/865,387

(22) Filed: Jul. 15, 2022

(30) Foreign Application Priority Data
Jul. 19, 2021 (JP) 2021-118608

(51) Int. Cl. B60L 53/36; B60L 53/62

(52) U.S. Cl. CPC B60L 53/36; B60L 53/62

(57) ABSTRACT

An information processing apparatus accepts an inquiry about rental of a power feed mat that can supply electric power to a movable body. The power feed mat includes a substrate including a power transmission coil and a functional body that performs at least one function of a plurality of functions. The inquiry includes an instruction to designate the at least one function of the plurality of functions. In the information processing apparatus, association information in which function information is associated with identification information of each of a plurality of power feed mats is stored. The function information indicates which of the plurality of functions the power feed mat performs. The information processing apparatus specifies at least one power feed mat among the plurality of power feed mats based on the accepted inquiry and the association information and provides information based on a result of specifying.

This nonprovisional application is based on Japanese Patent Application No. 2021-118608 filed with the Japan Patent Office on Jul. 19, 2021, the entire contents of which are hereby incorporated by reference.

### BACKGROUND

### Field

The present disclosure relates to an information processing apparatus, an information processing system, and an information processing method.

### Description of the Background Art

A power feed mat that is portable and can wirelessly charge a vehicle and the like has conventionally been known. For example, Japanese Patent Laying-Open No. 2014-236540 discloses a power transmission coil member including a power transmission coil that transmits electromagnetic waves for power transmission to a power reception coil mounted on a vehicle and a sheet material which is a pliable sheet that covers the power transmission coil. This power transmission coil member is portable.

### SUMMARY

A location where the power feed mat is used or a purpose of use thereof is different depending on a user, and therefore a function desired therefor is different for each user.

An object of the present disclosure is to provide an information processing apparatus, an information processing system, and an information processing method that allow appropriate rental of a power feed mat to a user.

According to one aspect of the present disclosure, an information processing apparatus includes acceptance means for accepting an inquiry about rental of a power feed mat that supplies electric power to a movable body. The power feed mat includes a substrate including a power transmission coil and a functional body that performs at least one function of a plurality of functions, the functional body being provided at at least one of a position above and a position below the substrate. The inquiry includes an instruction that designates the at least one function of the plurality of functions. The information processing apparatus further includes storage means in which association information in which function information is associated with identification information of each of a plurality of power feed mats is stored. The function information indicates which of the plurality of functions the power feed mat performs. The information processing apparatus further includes specifying means for specifying at least one power feed mat among the plurality of power feed mats based on the inquiry accepted by the acceptance means and the association information and output means for providing information based on a result of specifying by the specifying means.

According to such a configuration, the information processing apparatus can specify a power feed mat based on the inquiry, among the plurality of power feed mats. Specifically, the information processing apparatus can specify a power feed mat that performs a function designated in the inquiry. Therefore, the power feed mat can appropriately be rented to a user who has made the inquiry.

According to another aspect of the present disclosure, an information processing apparatus includes acceptance means for accepting an inquiry about rental of a substrate that supplies electric power to a movable body and a functional material that can each be layered on the substrate. Each functional material performs at least one function of a plurality of functions. The inquiry includes an instruction that designates the at least one function of the plurality of functions. The information processing apparatus further includes storage means in which association information in which function information is associated with identification information of each of a plurality of functional materials is stored. The function information indicates which of the plurality of functions the functional material performs. The information processing apparatus further includes specifying means for specifying at least one functional material among the plurality of functional materials based on the inquiry accepted by the acceptance means and the association information and output means for providing information based on a result of specifying by the specifying means.

According to such a configuration, the information processing apparatus can specify a functional material based on the inquiry, among the plurality of functional materials. Specifically, the information processing apparatus can specify a functional material that performs a function designated in the inquiry. Therefore, a power feed mat which is a set of the substrate and the functional material can appropriately be rented to a user who has made the inquiry.

Preferably, one of the plurality of functions is a function to reduce occurrence of stress concentration in the substrate, a waterproof function, or a snow melting function.

According to such a configuration, the power feed mat with the function to reduce occurrence of stress concentration in the substrate, the waterproof function, or the snow melting function can be rented.

Preferably, one of the plurality of functions is a function to radiate heat of the substrate or a function to cut off electromagnetic waves to the substrate.

According to such a configuration, the power feed mat with the function to radiate heat of the substrate or the function to cut off electromagnetic waves to the substrate can be rented.

Preferably, one of the plurality of functions is a representation function.

According to such a configuration, the power feed mat with the representation function can be rented.

Preferably, one of the plurality of functions is a function to communicate with the movable body.

According to such a configuration, the power feed mat with a communication function to communicate with the movable body can be rented.

Preferably, the substrate includes an antenna that communicates with the movable body.

According to such a configuration, the power feed mat with a communication function to communicate with the movable body can be rented.

Preferably, the acceptance means accepts the inquiry from a terminal device communicatively connected to the information processing apparatus. The output means notifies the terminal device of the result of specifying.

According to such a configuration, a power feed mat with a communication function to communicate with a movable body can be rented.

According to yet another aspect of the present disclosure, an information processing system includes the information processing apparatus described above and the terminal device.

According to such a configuration, the power feed mat can appropriately be rented to a user who has made the inquiry.

According to yet another aspect of the present disclosure, an information processing method includes accepting, by an information processing apparatus, an inquiry about rental of a power feed mat that supplies electric power to a movable body. The power feed mat includes a substrate including a power transmission coil and a functional body that performs at least one function of a plurality of functions, the functional body being provided at at least one of a position above and a position below the substrate. The inquiry includes an instruction that designates the at least one function of the plurality of functions. The information processing method further includes specifying, by the information processing apparatus, at least one power feed mat among a plurality of power feed mats based on the accepted inquiry and association information in which function information is associated with identification information of each of the plurality of power feed mats. The function information indicates which of the plurality of functions the power feed mat performs. The information processing method further includes providing, by the information processing apparatus, information based on a result of specifying.

According to such a configuration, the information processing apparatus can specify a power feed mat based on the inquiry, among the plurality of power feed mats. Specifically, the information processing apparatus can specify a power feed mat that performs a function designated in the inquiry. Therefore, a power feed mat can appropriately be rented to a user who has made the inquiry.

According to yet another aspect of the present disclosure, an information processing method includes accepting, by an information processing apparatus, an inquiry about rental of a substrate that supplies electric power to a movable body and a functional material that can each be layered on the substrate. Each functional material performs one of a plurality of functions. The inquiry includes an instruction that designates at least one function of the plurality of functions. The information processing method further includes specifying, by the information processing apparatus, at least one functional material among a plurality of functional materials based on the accepted inquiry and association information in which function information is associated with identification information of each of the plurality of functional materials. The function information indicates which of the plurality of functions the functional material performs. The information processing method further includes providing, by the information processing apparatus, information based on a result of specifying.

According to such a configuration, the information processing apparatus can specify a functional material based on the inquiry, among the plurality of functional materials. Specifically, the information processing apparatus can specify a functional material that performs a function designated in the inquiry. Therefore, a power feed mat which is a set of the substrate and the functional material can appropriately be rented to a user who has made the inquiry.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing a configuration of a wireless charging system including a power feed mat.

FIG. 2 is an exemplary cross-sectional view along the line ii-ii in FIG. 1.

FIG. 3 is another exemplary cross-sectional view along the line ii-ii in FIG. 1.

FIG. 4 is yet another exemplary cross-sectional view along the line ii-ii in FIG. 1.

FIG. 5 is a diagram illustrating a schematic configuration of an information processing system.

FIG. 6 is a block diagram showing a typical hardware configuration of a server apparatus.

FIG. 7 is a block diagram showing a typical hardware configuration of a terminal device.

FIG. 8 is a functional block diagram for illustrating a functional configuration of the server apparatus and the terminal device included in the information processing system.

FIG. 9 is a diagram for illustrating a schematic configuration of a data table.

FIG. 10 is a diagram for illustrating a schematic configuration of another data table.

FIG. 11 is a diagram showing an input screen for making an inquiry about rental of a power feed mat.

FIG. 12 is a diagram showing a screen of a result of an estimate based on a result of specifying.

FIG. 13 is a sequence diagram for illustrating a flow of processing performed in the information processing system.

FIG. 14 is a functional block diagram for illustrating a functional configuration of another server apparatus and the terminal device included in the information processing system.

FIG. 15 is a diagram for illustrating how another power feed mat is constructed.

FIGS. 16 and 17 are each a diagram for illustrating a schematic configuration of yet another data table.

### DESCRIPTION OF THE PREFERRED EMBODIMENTS

Each embodiment of the present disclosure will be described below in detail with reference to the drawings. The same or corresponding elements in the drawings have the same reference characters allotted and description thereof will not be repeated. In the drawings, illustration is not in accordance with an actual dimensional ratio. For facilitating understanding of a structure, there are illustrations where the ratio is modified to clarify the structure.

### First Embodiment

### A. Power Feed Mat

A schematic configuration of a power feed mat to be rented in the present embodiment and exemplary use of the power feed mat will be described.

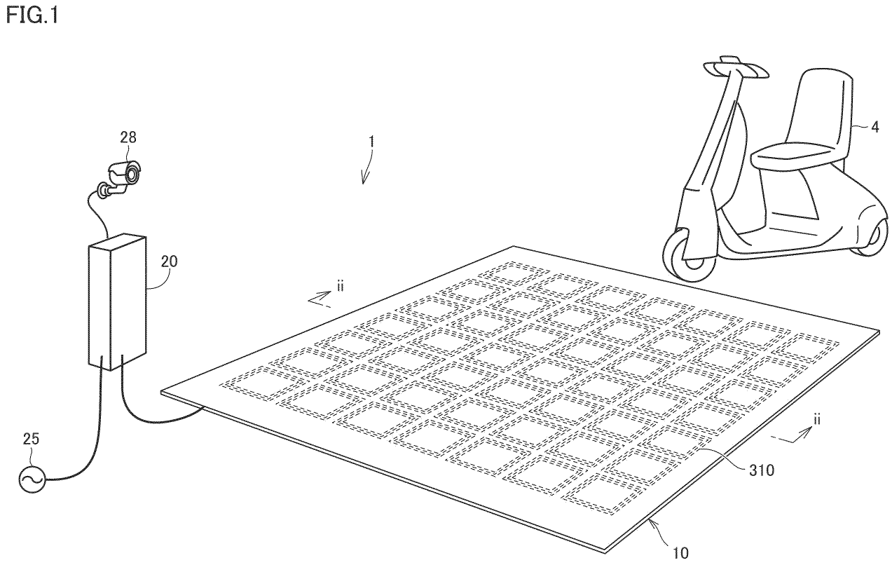

FIG. 1 is a perspective view schematically showing a configuration of a wireless charging system including a power feed mat. As shown in FIG. 1, a power feed mat 10 is used by a movable body 4. Movable body 4 includes a power reception coil and a power storage that are not shown.

Examples of movable body 4 include a vehicle, a micropalette, and an unmanned aerial vehicle (UVA) which is also referred to as a drone. Examples of the vehicle include a small mobility with a seat capacity of one or two passengers as shown in FIG. 1. Without being limited as such, the vehicle may be, for example, a hybrid electric vehicle (HEV), a plug-in hybrid electric vehicle (PHEV), a battery electric vehicle (BEV), or an autonomous vehicle capable of transporting a load without human intervention.

A wireless charging system 1 includes power feed mat 10 and a power feed apparatus 20.

Power feed mat 10 can wirelessly send electric power to movable body 4. Power feed mat 10 may be placed on a road surface or the like or on a wall surface. Power feed mat 10 may be flexible or pliable as being rolled. Specifically, power feed mat 10 includes a plurality of power transmission coils 310. Without being limited as such, power feed mat 10 may include a single power transmission coil 310.

Power transmission coil 310 can wirelessly transmit electric power to a power reception coil mounted on movable body 4. While the power reception coil is located above power transmission coil 310, power transmission coil 310 sends electromagnetic waves for power transmission to that power reception coil. The power reception coil charges a power storage of movable body 4 with electric power generated based on the electromagnetic waves. Power transmission coil 310 may be formed in a quadrangular shape in a plan view as shown in FIG. 1 or in a hexagonal shape in the plan view. Alternatively, power transmission coil 310 may be formed in a shape different from the quadrangular shape and the hexagonal shape in the plan view.

Power feed apparatus 20 supplies electric power to power feed mat 10. Power feed apparatus 20 can be connected to an alternating-current (AC) power supply 25. Power feed apparatus 20 converts a voltage of AC power supplied from AC power supply 25 into an appropriate value and supplies resultant AC power to power feed mat 10.

Power feed apparatus 20 may include a sensor unit 28. Sensor unit 28 detects a position of movable body 4 that passes over power feed mat 10. Sensor unit 28 includes at least one of a camera, a radar, and a laser imaging detection and ranging (LIDAR).

An information processing system for rental of the power feed mat described above will be described below.

Rented power feed mat 10 performs various functions (which are also referred to as “additional functions” below) other than a power feed function as a basic function. In the present example, a type of power feed mat 10 is set depending on the additional function. A single power feed mat 10 performs a single additional function or a plurality of additional functions. The additional function is performed by a functional layer which will be described later. In the present example, power feed mat 10 is rented in consideration of the additional function of power feed mat 10.

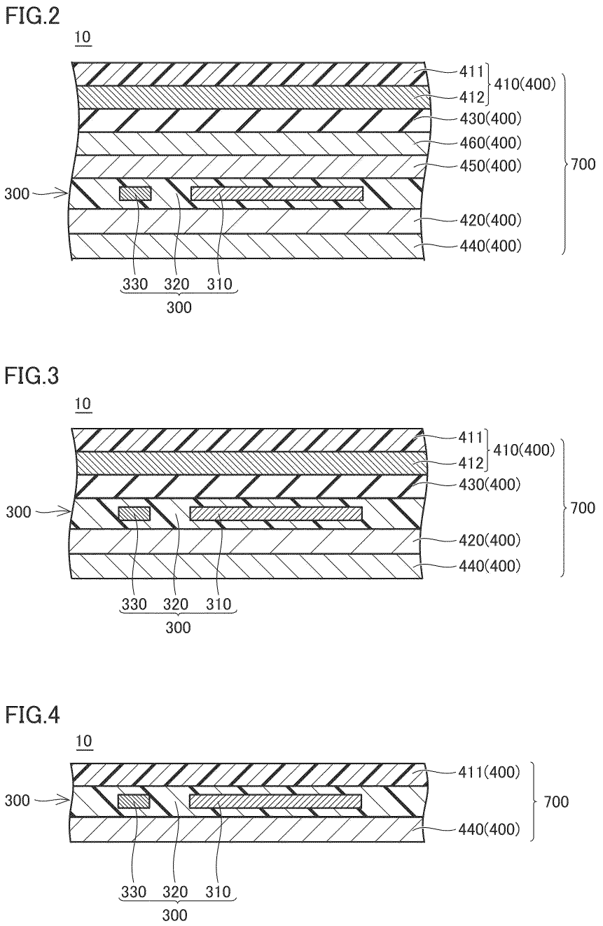

Overview of three types of power feed mats 10 will be described with reference to FIGS. 2 to 4. Power feed mats 10 shown in FIGS. 2 to 4 represent exemplary configurations of power feed mats 10, and the type of power feed mat 10 is not limited to these three types. Power feed mat 10 with only the power feed function is also rented.

FIG. 2 is an exemplary cross-sectional view along the line ii-ii in FIG. 1.

As shown in FIG. 2, power feed mat 10 includes a substrate 300 and a functional body 700. Functional body 700 includes a plurality of functional layers 400. Each functional layer 400 is provided at at least one of a position above and a position below substrate 300. Each functional layer 400 is provided above or below substrate 300 depending on a function.

Substrate 300 includes at least one power transmission coil 310, a cover sheet 320, and an antenna 330. In the present embodiment, substrate 300 includes a plurality of power transmission coils 310.

Cover sheet 320 covers power transmission coil 310. Cover sheet 320 is composed of glass, an epoxy resin, or the like.

Antenna 330 is provided within cover sheet 320. Antenna 330 is, for example, a loop antenna. Antenna 330 superimposes on electromagnetic waves sent from power transmission coil 310 to a power reception coil of movable body 4, information lower in frequency than the electromagnetic waves. Examples of the information include position information of movable body 4, an amount of power feed requested by movable body 4, and an identification number of movable body 4.

Power feed mat 10 includes as a plurality of functional layers 400, an upper protective layer 410, a heat radiation layer 420, a representation layer 430, a lower protective layer 440, a foreign matter sensing layer 450, and a living body sensing layer 460.

Upper protective layer 410 performs a function to protect substrate 300.

Upper protective layer 410 is provided above substrate 300. In the present example, upper protective layer 410 performs as the function to protect substrate 300, a function to reduce occurrence of stress concentration (which is also referred to as a “load-carrying function” or a “vibration resistant function”), a waterproof function, and a snow-melting function. In the present embodiment, upper protective layer 410 includes a first protective layer 411 that performs the function to reduce occurrence of stress concentration and the waterproof function and a second protective layer 412 that performs the snow-melting function.

First protective layer 411 reduces occurrence of stress concentration to substrate 300 caused by a weight of movable body 4 and improves waterproofness of substrate 300. First protective layer 411 is composed of a material (polycarbonate or the like) higher in rigidity than cover sheet 320 or a material (rubber or the like) lower in rigidity than cover sheet 320. First protective layer 411 is preferably composed of a light-transmissive material.

Second protective layer 412 is provided on a lower surface of first protective layer 411. Second protective layer 412 includes a heating unit such as a heater. This heating unit is activated when accumulation of snow on first protective layer 411 is sensed. Second protective layer 412 is preferably composed of a light-transmissive material.

Heat radiation layer 420 performs a function to radiate heat of substrate 300. Heat radiation layer 420 can be provided as being in contact with an upper surface or a lower surface of substrate 300. In the present embodiment, heat radiation layer 420 is provided as being in contact with the lower surface of substrate 300. Heat radiation layer 420 is composed of a material higher in thermal conductivity than cover sheet 320 of substrate 300. Heat radiation layer 420 is formed, for example, by adding thermally conductive particles to silicone rubber. Heat radiation layer 420 can also be provided as being in contact with the upper surface of substrate 300.

Representation layer 430 performs a representation function. Representation layer 430 is provided above substrate 300. When upper protective layer 410 is provided above substrate 300, representation layer 430 is provided between substrate 300 and upper protective layer 410. Representation layer 430 can provide prescribed representation by optical representation. Examples of the prescribed representation include representation that guides movable body 4. The prescribed representation is changed as appropriate by power feed apparatus 20. Representation by representation layer 430 can be read by a camera (not shown) mounted on movable body 4.

Lower protective layer 440 performs a function to protect substrate 300. Lower protective layer 440 is provided below substrate 300. In the present example, lower protective layer 440 is provided below heat radiation layer 420. Lower protective layer 440 performs a function to cut off electromagnetic waves. Lower protective layer 440 contains a material (a metal or ferrite) capable of cutting off electromagnetic waves.

Foreign matter sensing layer 450 performs a function to sense a foreign matter present above substrate 300. Foreign matter sensing layer 450 is provided above substrate 300. Foreign matter sensing layer 450 is provided as being in contact with the upper surface of substrate 300. Foreign matter sensing layer 450 includes a coil that detects a metal.

Living body sensing layer 460 performs a function to sense a living body (a human or an animal) present above substrate 300. Living body sensing layer 460 is provided above substrate 300. As shown in FIG. 2, living body sensing layer 460 may be provided as being in contact with an upper surface of foreign matter sensing layer 450 or with the upper surface of substrate 300. Living body sensing layer 460 includes, for example, a sensor that senses a capacitance.

FIG. 3 is another exemplary cross-sectional view along the line ii-ii in FIG. 1.

As shown in FIG. 3, power feed mat 10 includes substrate 300 and functional body 700 as in FIG. 2. Functional body 700 includes a plurality of functional layers 400. Each functional layer 400 is provided at at least one of a position above and a position below substrate 300. Each functional layer 400 is provided above or below substrate 300 depending on a function.

Specifically, in an example in FIG. 3, power feed mat 10 includes as the plurality of functional layers 400, upper protective layer 410, heat radiation layer 420, representation layer 430, and lower protective layer 440. Power feed mat 10 in the present example is different from power feed mat 10 in FIG. 2 in not including foreign matter sensing layer 450 and living body sensing layer 460.

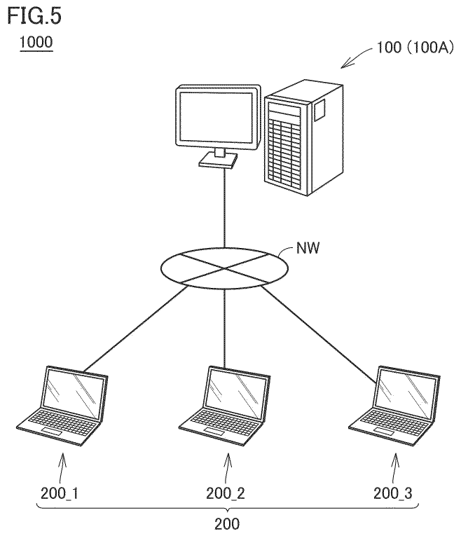

FIG. 4 is yet another exemplary cross-sectional view along the line ii-ii in FIG. 1. As shown in FIG. 4, power feed mat 10 includes substrate 300 and functional body 700 as in FIGS. 2 and 3. Functional body 700 includes a plurality of functional layers 400. Each functional layer 400 is provided at at least one of a position above and a position below substrate 300. Each functional layer 400 is provided above or below substrate 300 depending on a function.

Specifically, in an example in FIG. 4, power feed mat 10 includes as the plurality of functional layers 400, first protective layer 411 and lower protective layer 440. Power feed mat 10 in the present example is different from power feed mat 10 in FIG. 2 in not including second protective layer 412, heat radiation layer 420, representation layer 430, foreign matter sensing layer 450, and living body sensing layer 460.

A power generation layer that performs a power generation function may be provided as functional layer 400. The power generation layer is preferably composed of a solar photovoltaic panel. The power generation layer may be provided, for example, instead of representation layer 430.

In the present example, an order of layering (an upward direction and a downward direction) of each functional layer 400 with respect to substrate 300 is determined depending on relation with the function of functional layer 400 and the function of another functional layer 400. There is a functional layer 400 a layering position of which is uniquely defined, such as lower protective layer 440, whereas there is a functional layer 400 a layering position of which is not uniquely defined.

In the description above, functional body 700 is composed of a plurality of functional layers 400 and provides a plurality of additional functions. The functional body, however, is not limited as such. Functional body 700 may be made up of a single functional layer 400 and may be configured to provide a single additional function. Thus, the “functional body” refers to a concept including at least one functional layer.

### B. Schematic Configuration of Information System

FIG. 5 is a diagram illustrating a schematic configuration of an information processing system in the present embodiment.

As shown in FIG. 5, an information processing system 1000 includes a server apparatus 100 and a plurality of terminal devices 200_1, 200_2, 200_3, ... For the sake of convenience of description, any one terminal device of terminal devices 200_1, 200_2, 200_3, ... is referred to as a “terminal device 200” below.

Server apparatus 100 and each terminal device 200 are communicatively connected to each other over a network NW. Though FIG. 5 shows three terminal devices 200, the number of terminal devices 200 is not limited thereto.

Server apparatus 100 is, for example, a server of a rental business operator that rents power feed mat 10. Alternatively, server apparatus 100 is a shared server shared by a plurality of business operators including the rental business operator. Alternatively, server apparatus 100 is a cloud server provided by a cloud server management company.

Each terminal device 200 is a communication device used by a user who uses a power feed mat rental service provided by the rental business operator. For example, terminal device 200_1 is used in one company while terminal device 200_2 is used in another company. A business category of a company that uses the rental service is not particularly limited.

### C. Hardware Configuration of Device

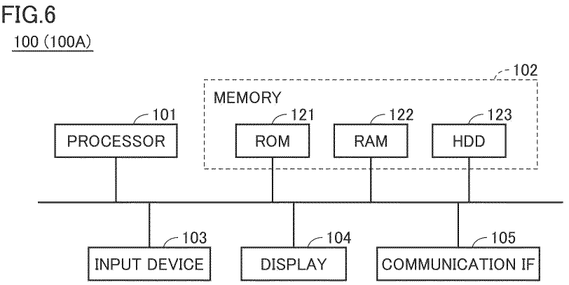

FIG. 6 is a block diagram showing a typical hardware configuration of server apparatus 100.

As shown in FIG. 6, server apparatus 100 includes a processor 101, a memory 102, an input device 103, a display 104, and a communication interface (IF) 105. Memory 102 includes a read only memory (ROM) 121, a random access memory (RAM) 122, and a hard disk drive (HDD) 123.

Processor 101 is communicatively connected to ROM 121, RAM 122, HDD 123, input device 103, display 104, and communication IF 105 through a bus or the like.

Processor 101 controls overall operations of server apparatus 100. Processor 101 executes an operating system and an application program stored in memory 102.

Input device 103 accepts an input from a user. Input device 103 is typically implemented by a keyboard and/or a mouse. Various types of information are shown on display 104. Communication IF 105 is an interface for communication with each terminal device 200.

Server apparatus 100 may include another non-volatile storage (for example, a solid state drive (SSD)) instead of or together with HDD 123.

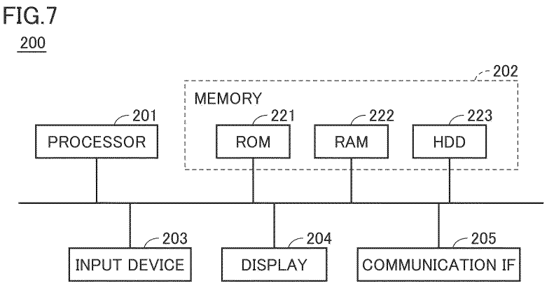

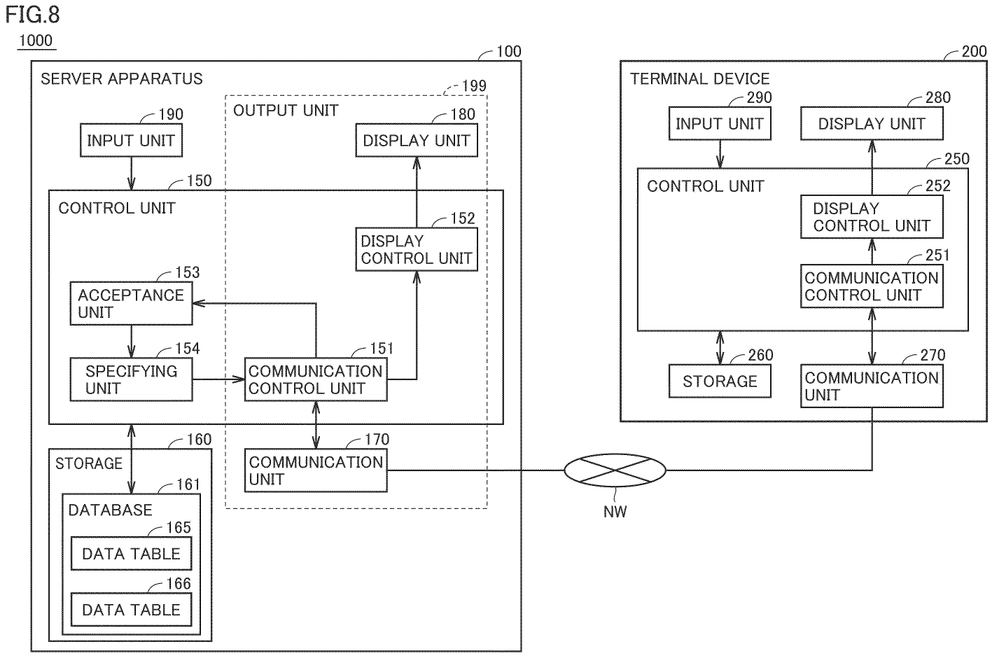

FIG. 7 is a block diagram showing a typical hardware configuration of terminal device 200.

As shown in FIG. 7, terminal device 200 includes a processor 201, a memory 202, an input device 203, a display 204, and a communication IF 205. Memory 202 includes a ROM 221, a RAM 222, and an HDD 223.

Processor 201 is communicatively connected to ROM 221, RAM 222, HDD 223, input device 203, display 204, and communication IF 205 through a bus or the like.

Processor 201 controls overall operations of terminal device 200. Processor 201 executes an operating system and an application program stored in memory 202.

Input device 203 accepts an input from a user. Input device 203 is typically implemented by a keyboard and/or a mouse. Various types of information are shown on display 204. Communication IF 205 is an interface for communication with server apparatus 100.

Similarly to server apparatus 100, terminal device 200 may include another non-volatile storage (for example, an SSD) instead of or together with HDD 223.

### D. Functional Configuration of System

FIG. 8 is a functional block diagram for illustrating a functional configuration of server apparatus 100 and terminal device 200 included in information processing system 1000.

### D1. Terminal Device 200

As shown in FIG. 8, terminal device 200 includes a control unit 250, a storage 260, a communication unit 270, a display unit 280, and an input unit 290. Control unit 250 includes a communication control unit 251 and a display control unit 252.

Control unit 250 controls overall operations of terminal device 200. Control unit 250 is a functional block implemented by execution by processor 201, of an operating system and an application program stored in memory 202.

Communication control unit 251 controls communication with the outside (server apparatus 100 in the present example) through communication unit 270. Communication unit 270 corresponds to communication IF 205 in FIG. 7.

Display control unit 252 controls screen display on display unit 280. Display unit 280 corresponds to display 204 in FIG. 7.

Input unit 290 accepts an input operation from a user of terminal device 200. Input unit 290 sends a signal based on an input operation to control unit 250. Input unit 290 corresponds to input device 203 in FIG. 7.

An operating system and an application program are stored in storage 260. Storage 260 corresponds to memory 202 in FIG. 7. In the present example, a web browser or the like is stored as the application program.

Data on rental of power feed mat 10 is transmitted through communication unit 270 and network NW in accordance with an operation by the user through input unit 290. For example, an ID of the user, a password of the user, inquiry data for an estimate, and data (signal) for placing a firm order are transmitted from terminal device 200 to server apparatus 100.

Terminal device 200 receives data from server apparatus 100 through network NW and communication unit 270. Terminal device 200 receives a response signal from server apparatus 100 in accordance with a request signal from terminal device 200.

Terminal device 200 typically receives data (an HTML file, image data, or the like) for showing a web page from server apparatus 100. Specifically, data for showing a web page for logging into server apparatus 100, data for showing a data input web page for an estimate, data for showing a web page for placing a firm order (for a formal order and for making a firm reservation), or the like is received from server apparatus 100. An exemplary screen shown on terminal device 200 will be described later.

### D2. Server Apparatus 100

Server apparatus 100 includes a control unit 150, a storage 160, a communication unit 170, a display unit 180, and an input unit 190. Control unit 150 includes a communication control unit 151, a display control unit 152, an acceptance unit 153, and a specifying unit 154. A database 161 is stored in storage 160. An output unit 199 includes communication control unit 151, communication unit 170, display control unit 152, and display unit 180.

Control unit 150 controls overall operations of server apparatus 100. Control unit 150 is a functional block implemented by execution by processor 101, of an operating system and an application program stored in memory 102.

Communication control unit 151 controls communication with the outside (terminal device 200 in the present example) through communication unit 170. Communication unit 170 corresponds to communication IF 105 in FIG. 6.

Display control unit 152 controls screen display on display unit 180. Display unit 180 corresponds to display 104 in FIG. 6.

Input unit 190 accepts an input operation from a user of server apparatus 100. Input unit 190 sends a signal based on an input operation to control unit 150. Input unit 190 corresponds to input device 103 in FIG. 6.

An operating system, an application program, and database 161 are stored in storage 160. Storage 160 corresponds to memory 102 in FIG. 6.

In database (association information) 161, function information is associated with identification information of each of the plurality of power feed mats 10. The function information indicates which of the plurality of functions power feed mat 10 performs. Specifically, database 161 includes a data table 165 and a data table 166.

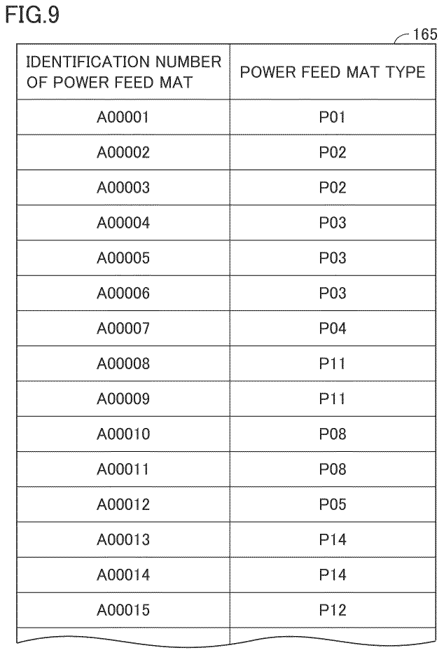

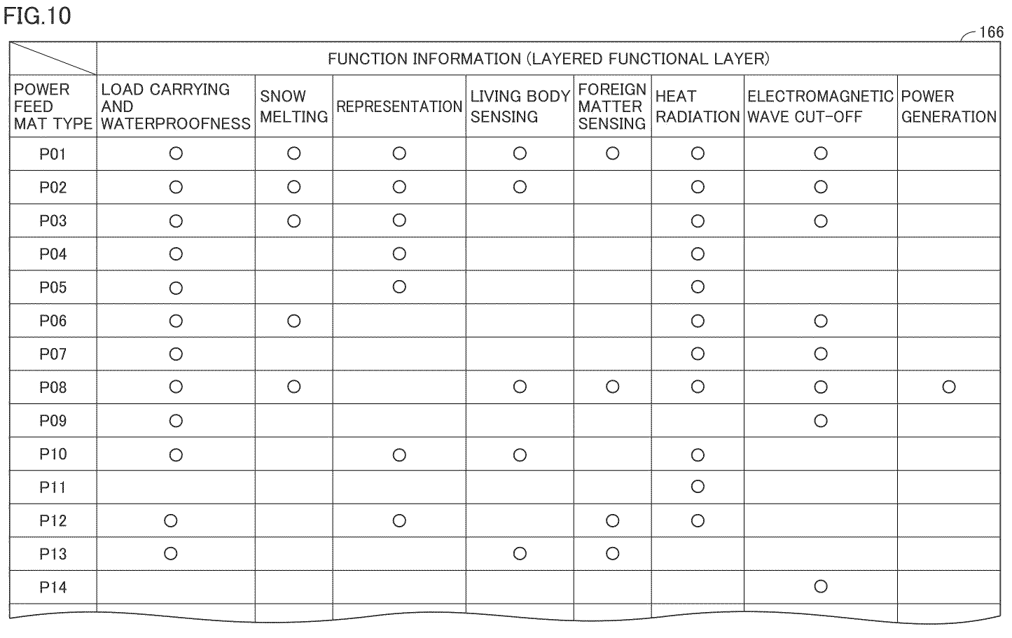

FIG. 9 is a diagram for illustrating a schematic configuration of data table 165. FIG. 10 is a diagram for illustrating a schematic configuration of data table 166.

As shown in FIG. 9, in data table 165, identification information of the power feed mat and a power feed mat type are brought in correspondence with each other. In the present example, one of a plurality of power feed mat types (P01, P02, P03, ...) is brought in correspondence with identification information (A00001, A00002, ...) of the power feed mats. For example, the power feed mat type “P01” is brought in correspondence with identification information “A00001” of the power feed mat.

As shown in FIG. 10, in data table 166, function information is brought in correspondence with each of the plurality of power feed mat types. Specifically, in data table 166, information indicating the layered functional layer is brought in correspondence with the power feed mat type.

For example, information indicating provision of the load-carrying and waterproof functional layer, the snow-melting functional layer, the representation functional layer, the living body sensing functional layer, the foreign matter sensing functional layer, the heat radiation functional layer, and the electromagnetic wave cutting-off functional layer is brought in correspondence with power feed mat type “P01”. In other words, data table 166 shows that power feed mat 10 of power feed mat type “P01” includes the load-carrying and waterproof functional layer, the snow-melting functional layer, the representation functional layer, the living body sensing functional layer, the foreign matter sensing functional layer, the heat radiation functional layer, and the electromagnetic wave cutting-off functional layer. Similarly, data table 166 shows that power feed mat 10 of another power feed mat type includes the functional layer that performs a function shown with a circle in data table 166.

Thus, in database 161, the function information indicating which of the plurality of functions power feed mat 10 performs is associated with identification information of each of the plurality of managed power feed mats 10 by association of the power feed mat type (P01, P02, ...) between data table 165 and data table 166. In other words, database 161 shows which of the plurality of functions each of the plurality of power feed mats 10 performs.

Though database 161 including two data tables 165 and 166 is described in the present example by way of example, the configuration of database 161 is not limited thereto. The configuration of database 161 is not particularly limited so long as the database shows which of the plurality of functions each of the plurality of power feed mats 10 performs.

Referring again to FIG. 8, acceptance unit 153 accepts an inquiry about rental of power feed mat 10. Acceptance unit 153 accepts an inquiry about rental of power feed mat 10 from terminal device 200 through communication unit 170 and communication control unit 151. When acceptance unit 153 accepts an inquiry about rental, acceptance unit 153 notifies specifying unit 154 of the accepted inquiry.

Specifying unit 154 specifies at least one power feed mat 10 among the plurality of power feed mats 10 managed by server apparatus 100 based on the inquiry accepted by acceptance unit 153 and database 161. A specific specifying method will be described after explanation of an exemplary screen shown on terminal device 200.

Output unit 199 provides output of a result of specifying by specifying unit 154. Typically, output unit 199 (in particular, communication control unit 151 and communication unit 170) transmits a result of specifying to terminal device 200 from which the inquiry was made. Output unit 199 (in particular, display control unit 152 and display unit 180) shows the result of specifying.

Furthermore, acceptance unit 153 accepts an instruction to place a firm order from terminal device 200 through communication unit 170 and communication control unit 151. The firm order of power feed mat 10 is thus placed. When the firm order is placed, control unit 150 transmits data indicating placement of the firm order (data for showing a web page) to terminal device 200 that placed the order.

### E. User Interface of Terminal Device

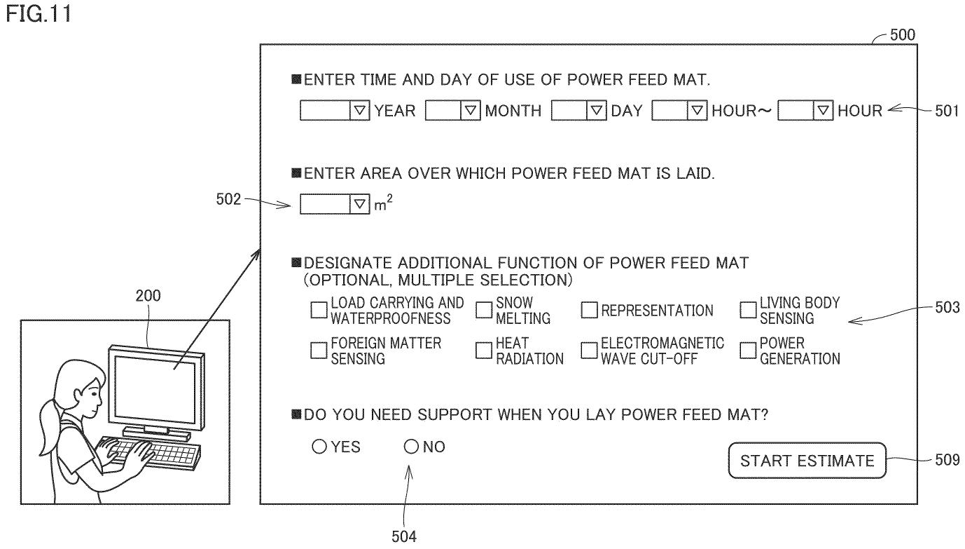

FIG. 11 is a diagram showing an input screen for making an inquiry about rental of power feed mat 10. FIG. 11 also shows a screen for obtaining an estimate of rental of power feed mat 10. As a user logs in information processing system 1000 with the use of terminal device 200, a screen shown in FIG. 11 is shown on terminal device 200.

As shown in FIG. 11, an input screen 500 includes an input field 501 for entry of a period of use, an input field 502 for entry of an area over which power feed mat 10 is laid, a plurality of check boxes 503 for designating an additional function of the power feed mat, a radio button 508 for designating whether or not support is required for laying power feed mat 10, and a GUI button 509 for indicating start of an estimate.

In input screen 500, as the user performs an operation to check at least one check box among the plurality of check boxes 503, the additional function is designated. In other words, the function of power feed mat 10 desired by the user is designated through input screen 500.

In the present example, power feed mats 10 are assumed as being identical in size (longitudinal and lateral sizes). The number of necessary power feed mats 10 can be determined based on the area over which power feed mat 10 is laid. Power feed mats 10 do not necessarily have to be identical in size. In such a case, information on the size of the power feed mat should only be brought in correspondence with the identification information of power feed mat 10 in data table 165.

Items in input screen 500 for making an inquiry about rental are not limited as above. When power feed mat 10 in a single size is available, input of the number of power feed mats 10 instead of the area may be accepted. When power feed mats 10 in a plurality of sizes are available, input designating the size and input of the number of power feed mats may be accepted.

The user of terminal device 200 enters each item in input screen 500, and thereafter selects button 509. Then, information on each item entered in input screen 500 is transmitted to server apparatus 100.

Server apparatus 100 specifies power feed mat 10 to be rented to the user among the plurality of power feed mats 10 managed thereby, based on information on the user and information entered in input screen 500. Server apparatus 100 gives information based on a result of specifying to terminal device 200. Specifically, server apparatus 100 makes an estimate of power feed mat 10 and notifies terminal device 200 of a result of the estimate.

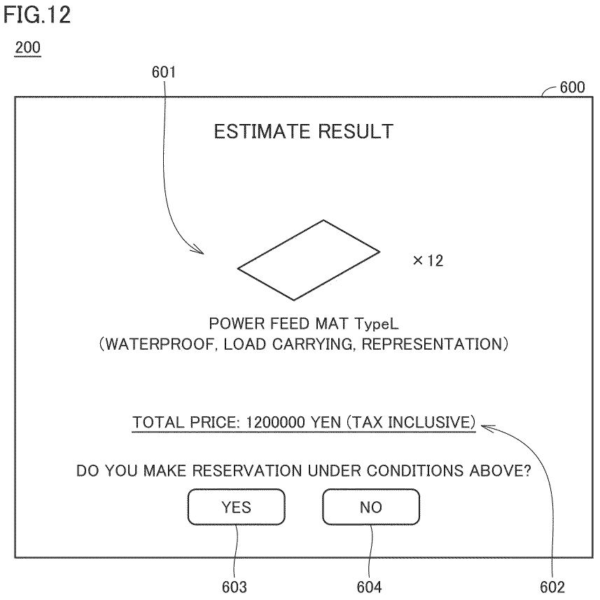

FIG. 12 is a diagram showing a screen of a result of an estimate based on a result of specifying.

As shown in FIG. 12, terminal device 200 shows a screen 600 including information 601 including a type of power feed mat 10 and the number of power feed mats, information 602 on a total amount, a button 603 for making a reservation, and a button 604 for not making a reservation. Screen 600 may include information on a period of use or the like.

When the user selects button 603, reservation of power feed mat 10 is completed in server apparatus 100.

### F. Processing for Specifying Power Feed Mat

An inquiry from the user includes information on a period of use, information on an area, and information designating the additional function as described above. Server apparatus 100 specifies at least one power feed mat 10 among the plurality of power feed mats 10 managed thereby, based on the information included in the inquiry. Server apparatus 100 specifies power feed mat 10 that conforms to such information. Server apparatus 100 specifies power feed mat 10 that meets at least a request from the user. When power feed mats 10 that meet the request from the user are not sufficiently available, server apparatus 100 may select power feed mat 10 higher in spec. Specifying processing will be described below with reference to a plurality of examples.

For example, when the check box for load carrying and waterproofness, the check box for snow melting, the check box for representation, the check box for heat radiation, the check box for electromagnetic cut-off, the check box for foreign matter sensing, and a check box for living body sensing are checked in input screen 500, server apparatus 100 specifies, by referring to data table 165 and data table 166, power feed mat 10 the power feed mat type of which is “P01” among the plurality of power feed mats 10. Specifically, specifying unit 154 specifies power feed mat 10 with the structure shown in FIG. 2 among the plurality of power feed mats 10.

Specifically, specifying unit 154 specifies a necessary number of power feed mats 10 the power feed mat type of which is “P01”, based on area information. More specifically, specifying unit 154 specifies power feed mat 10 the power feed mat type of which is “P01”, in consideration of information on the period of use.

Alternatively, when the check box for load carrying and waterproofness, the check box for snow melting, the check box for representation, the check box for heat radiation, and the check box for electromagnetic cut-off are checked in input screen 500, server apparatus 100 specifies, by referring to data table 165 and data table 166, power feed mat 10 the power feed mat type of which is “P03”, among the plurality of power feed mats 10. Specifically, specifying unit 154 specifies power feed mat 10 with the structure shown in FIG. 3 among the plurality of power feed mats 10.

Alternatively, when the check box for load carrying and waterproofness and the check box for electromagnetic cut-off are checked in input screen 500, server apparatus 100 specifies, by referring to data table 165 and data table 166, power feed mat 10 the power feed mat type of which is “P09”, among the plurality of power feed mats 10. Specifically, specifying unit 154 specifies power feed mat 10 with the structure shown in FIG. 4 among the plurality of power feed mats 10.

As set forth above, server apparatus 100 specifies, by referring to database 161, power feed mat 10 (power feed mat 10 that can be rented) as desired by the user among the plurality of power feed mats 10 managed thereby, based on checking of the check box on input screen 500.

### G. Processing Sequence

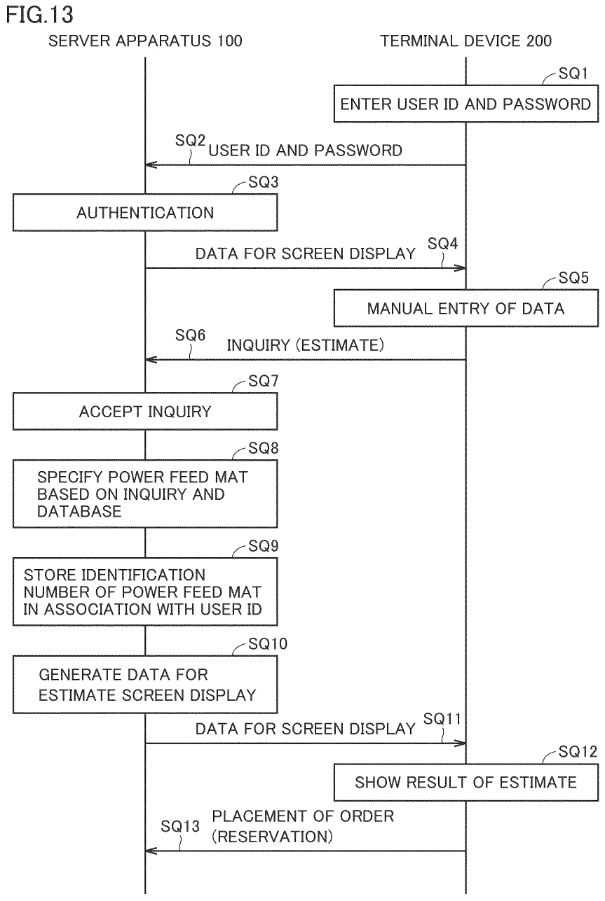

FIG. 13 is a sequence diagram for illustrating a flow of processing performed in information processing system 1000.

As shown in FIG. 13, in sequence SQ1, terminal device 200 accepts entry of a user ID and a password. In sequence SQ2, terminal device 200 transmits the user ID and the password to server apparatus 100. In sequence SQ3, server apparatus 100 authenticates the user of terminal device 200 based on the received user ID and password.

In sequence SQ4, server apparatus 100 transmits data for showing inquiry input screen 500 (data for screen display) to terminal device 200. Specifically, server apparatus 100 transmits data for showing a web page to terminal device 200. In sequence SQ5, after input screen 500 is shown, terminal device 200 accepts inquiry data input into input screen 500 (see FIG. 11).

In sequence SQ6, terminal device 200 transmits inquiry information to server apparatus 100. Specifically, being triggered by selection of button 509 shown in FIG. 11, terminal device 200 transmits inquiry information to server apparatus 100.

In sequence SQ7, server apparatus 100 accepts the inquiry about rental of power feed mat 10. In sequence SQ8, server apparatus 100 specifies at least one power feed mat 10 among the plurality of power feed mats 10 based on the inquiry and database 161 (FIG. 8).

In sequence SQ9, server apparatus 100 has the user ID stored in association with identification information of power feed mat 10. Specifically, server apparatus 100 associates the user ID and the information on a period of use with the identification information of power feed mat 10.

In sequence SQ10, server apparatus 100 generates data for showing an estimate on terminal device 200 (data for screen display). In sequence SQ11, server apparatus 100 transmits the generated data for screen display to terminal device 200.

In sequence SQ12, terminal device 200 shows screen 600 showing a result of the estimate (see FIG. 12). In sequence SQ13, being triggered by selection of button 603 (FIG. 12) for making a reservation, terminal device 200 issues an order to server apparatus 100.

Thereafter, at prescribed timing, the manager of power feed mat 10 performs processing for bringing power feed mat 10 specified by server apparatus 100 from a location of storage of power feed mat 10 and delivering the power feed mat to the user. Through such a series of processing, power feed mat 10 is rented to the user.

### H. Modification

Though a configuration in which substrate 300 includes antenna 330 is described above by way of example, the configuration is not limited as such. In power feed mat 10 of one type, a functional layer that functions as antenna 330 may be provided separately from substrate 300.

In the above, first protective layer 411 performs two functions of the function to reduce occurrence of stress concentration and the waterproof function. Without being limited as such, a functional layer that reduces occurrence of stress concentration and a waterproof functional layer may be provided separately from each other.

### I. Summary

An illustrative embodiment described above is understood by a person skilled in the art as specific examples of aspects below.

Server apparatus 100 representing an exemplary information processing apparatus includes acceptance unit 153 that accepts an inquiry about rental of power feed mat 10 that supplies electric power to movable body 4. Power feed mat 10 includes substrate 300 including power transmission coil 310 and functional body 700 that performs at least one function of a plurality of functions, the functional body being provided at at least one of a position above and a position below substrate 300. The inquiry includes an instruction that designates the at least one function of the plurality of functions.

Server apparatus 100 further includes storage 160 in which database (association information) 161 in which function information is associated with identification information of each of a plurality of power feed mats 10 is stored. The function information indicates which function (at least one function) of the plurality of functions power feed mat 10 performs. Server apparatus 100 further includes specifying unit 154 that specifies at least one power feed mat 10 among the plurality of power feed mats 10 based on the inquiry accepted by acceptance unit 153 and database 161 and output unit 199 that provides information based on a result of specifying by specifying unit 154.

According to such a configuration, server apparatus 100 can specify power feed mat 10 based on the inquiry, among the plurality of power feed mats 10. Specifically, server apparatus 100 can specify power feed mat 10 that performs a function designated in the inquiry. Therefore, power feed mat 10 can appropriately be rented to a user who has made the inquiry.

One of the plurality of functions is a function to reduce occurrence of stress concentration in substrate 300, a waterproof function, or a snow melting function.

According to such a configuration, power feed mat 10 with the function to reduce occurrence of stress concentration in substrate 300, the waterproof function, or the snow melting function can be rented.

One of the plurality of functions is a function to radiate heat of substrate 300 or a function to cut off electromagnetic waves to substrate 300.

According to such a configuration, power feed mat 10 with the function to radiate heat of substrate 300 and the function to cut off electromagnetic waves to substrate 300 can be rented.

One of the plurality of functions is a representation function.

According to such a configuration, power feed mat 10 with the representation function can be rented.

One of the plurality of functions is a function to communicate with movable body 4.

According to such a configuration, power feed mat 10 with a communication function to communicate with movable body 4 can be rented.

Substrate 300 includes antenna 330 that communicates with movable body 4.

According to such a configuration, power feed mat 10 with a communication function to communicate with movable body 4 can be rented.

Acceptance unit 153 accepts the inquiry from terminal device 200 communicatively connected to server apparatus 100. Output unit 199 notifies terminal device 200 of the result of specifying. According to such a configuration, on terminal device 200, an inquiry about rental can be made and information based on specified power feed mat 10 can be checked.

An information processing method includes accepting, by server apparatus (information processing apparatus) 100, an inquiry about rental of power feed mat 10 that supplies electric power to movable body 4. Power feed mat 10 includes substrate 300 including power transmission coil 310 and functional body 700 that performs at least one function of a plurality of functions, functional body 700 being provided at at least one of a position above and a position below substrate 300. The inquiry includes an instruction that designates the at least one function of the plurality of functions.

The information processing method further includes specifying, by server apparatus 100, at least one power feed mat 10 among a plurality of power feed mats 10 based on the accepted inquiry and database (association information) 161 in which function information is associated with identification information of each of the plurality of power feed mats 10. The function information indicates which of the plurality of functions power feed mat 10 performs. The information processing method further includes providing, by server apparatus 100, information based on a result of specifying.

According to such a configuration, server apparatus 100 can specify power feed mat 10 based on the inquiry, among the plurality of power feed mats 10. Specifically, server apparatus 100 can specify power feed mat 10 that performs a function designated in the inquiry. Therefore, power feed mat 10 can appropriately be rented to a user who has made the inquiry.

A program causes processor 101 of server apparatus 100 to perform accepting an inquiry about rental of power feed mat 10 that supplies electric power to movable body 4. Power feed mat 10 includes substrate 300 including power transmission coil 310 and functional body 700 that performs at least one function of a plurality of functions, functional body 700 being provided at at least one of a position above and a position below substrate 300. The inquiry includes an instruction that designates the at least one function of the plurality of functions.

The program further causes processor 101 to perform specifying at least one power feed mat 10 among a plurality of power feed mats 10 based on the accepted inquiry and database (association information) 161 in which function information is associated with identification information of each of the plurality of power feed mats 10. The function information indicates which of the plurality of functions power feed mat 10 performs. The program further causes processor 101 to perform providing information based on a result of specifying.

According to such a configuration, server apparatus 100 can specify power feed mat 10 based on the inquiry, among the plurality of power feed mats 10. Specifically, server apparatus 100 can specify power feed mat 10 that performs a function designated in the inquiry. Therefore, power feed mat 10 can appropriately be rented to a user who has made the inquiry.

### Second Embodiment

In power feed mat 10 shown in the first embodiment described above, substrate 300 and functional body 700 are integrated. In other words, in power feed mat 10 in the first embodiment, at least one functional layer 400 has already been layered on substrate 300.

In the present embodiment, an aspect in which a power feed mat is constructed by freely combining a functional material that performs a prescribed additional function with substrate 300 will be described. A feature different from the first embodiment will be described, and description of the same feature will not be repeated.

For distinguishing a server apparatus in the present embodiment from server apparatus 100 in the first embodiment for the sake of convenience, the server apparatus in the present embodiment will be referred to as a “server apparatus 100A.” Since server apparatus 100A is the same as server apparatus 100 in hardware configuration, description thereof will not be repeated.

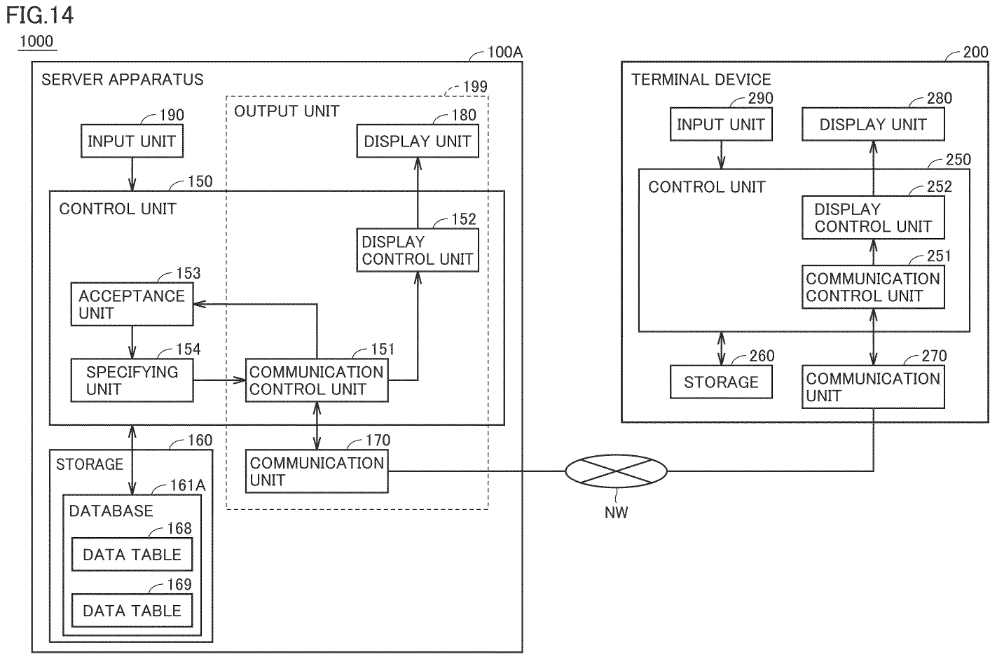

FIG. 14 is a functional block diagram for illustrating a functional configuration of server apparatus 100A and terminal device 200 included in information processing system 1000.

As shown in FIG. 14, server apparatus 100A is different in including a database 161A from server apparatus 100 including database 161. Database 161A includes a data table 168 and a data table 169. Details of these data tables 168 and 169 will be described later.

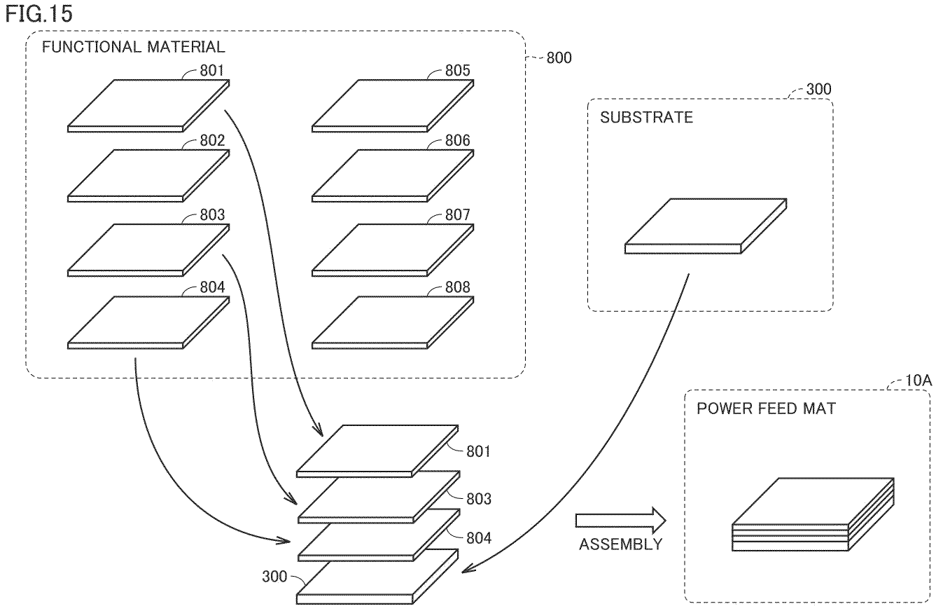

FIG. 15 is a diagram for illustrating how a power feed mat 10A in the present embodiment is constructed.

As shown in FIG. 15, server apparatus 100A specifies at least one functional material 800 among a plurality of functional materials 800 (801, 802, 803, ...) in response to an inquiry from a user. Functional material 800 may be in a form, for example, of a plate.

In the present example, functional material 801 performs a load-carrying and waterproof function. In other words, functional material 801 is the same in function as first protective layer 411 in the first embodiment. Similarly, functional material 802 performs a snow-melting function. In other words, functional material 802 is the same in function as second protective layer 412 in the first embodiment. Functional material 803 performs a representation function. In other words, functional material 803 is similar in function to representation layer 430 in the first embodiment.

A functional material 804 performs a living body sensing function. In other words, functional material 804 is similar in function to living body sensing layer 460 in the first embodiment. A functional material 805 performs a foreign matter sensing function. In other words, functional material 805 is similar in function to foreign matter sensing layer 450 in the first embodiment.

A functional material 806 performs a heat radiation function. In other words, functional material 806 is similar in function to heat radiation layer 420 in the first embodiment. A functional material 807 performs an electromagnetic wave cutting-off function. In other words, functional material 807 is similar in function to lower protective layer 440 in the first embodiment. A functional material 808 performs a power generation function.

Each functional material 800 and substrate 300 are constructed to be attachable and removable to and from each other in a direction of thickness (an upward/downward direction) of substrate 300. A structure that allows each functional material 800 and substrate 300 to be attachable and removable includes fitting by using projections and recesses, fastening with a fastening member such as a bolt, and connection by using a hook-and-loop fastener.

Server apparatus 100A specifies functional material 800 that performs a function desired by the user, among the plurality of functional materials 800 in response to an inquiry from the user of terminal device 200 (the user who uses the power feed mat rental service). The inquiry is made through input screen 500 (FIG. 11) also in the present embodiment.

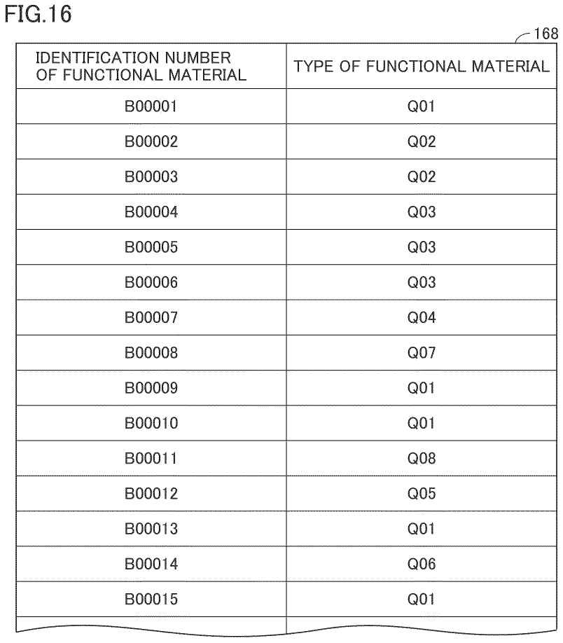

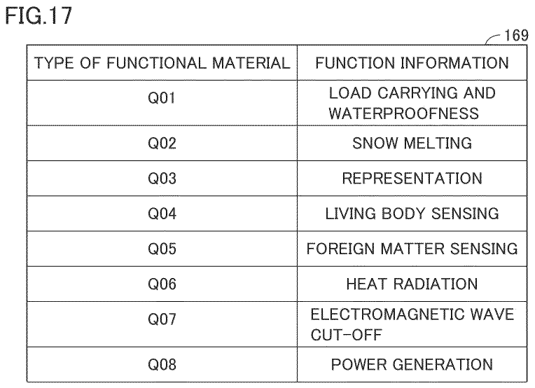

FIG. 16 is a diagram for illustrating a schematic configuration of data table 168. FIG. 17 is a diagram for illustrating a schematic configuration of data table 169.

As shown in FIG. 16, in data table 168, identification information of the functional material and the type of the functional material are brought in correspondence with each other. In the present example, one of a plurality of functional material types (Q01, Q02, Q03, ...) is brought in correspondence with identification information (B00001, B00002, ...) of the functional materials. For example, the functional material type “Q01” is brought in correspondence with identification information “B00001” of the functional material.

As shown in FIG. 17, in data table 169, the functional material type and information indicating the function of the functional material (function information) are brought in correspondence with each other. For example, information indicating the load-carrying and waterproof function is brought in correspondence with the functional material type “Q01”. In other words, data table 169 shows that functional material 800 of the type “Q01” performs the load-carrying and waterproof function.

Similarly, information indicating the snow-melting function is brought in correspondence with the functional material type “Q02”. Information indicating the representation function, the living body sensing function, the foreign matter sensing function, the heat radiation function, the electromagnetic wave cutting-off function, and the power generation function is brought in correspondence with other types Q03 to Q08, respectively.

Specifying unit 154 specifies at least one functional material 800 among the plurality of functional materials 800 based on information included in the inquiry from the user and database 161A (specifically, data tables 168 and 169). Server apparatus 100A specifies functional material 800 that conforms to such information. Server apparatus 100A specifies functional material 800 that meets at least a request from the user.

Server apparatus 100A has output unit 199 provide information based on a result of specifying by specifying unit 154. For example, server apparatus 100A has identification information of specified functional material 800 shown on display unit 180. Server apparatus 100A transmits an estimate result as information based on the result of specifying to terminal device 200 through communication unit 170.

A power feed mat 10A rental service provider (which is also referred to as a “service provider” below) brings specified functional material 800 and substrate 300 from a location of storage (a warehouse or the like). The service provider assembles power feed mat 10A by layering specified functional material 800 on substrate 300. Specifically, the service provider assembles power feed mat 10A on condition that it has received a formal order after the estimate. The service provider delivers assembled power feed mat 10A to the user.

In the case of FIG. 15, the service provider brings functional materials 801, 803, and 804 and substrate 300 from the location of storage. The service provider assembles power feed mat 10A by layering functional materials 801, 803, and 804 on substrate 300. The service provider delivers assembled power feed mat 10A to the user.

Though an example in which the service provider assembles power feed mat 10A is described above by way of example, limitation as such is not intended. The user may assemble power feed mat 10A. For example, an item for allowing the user to select whether or not to receive an assembly service may be added to input screen 500.

Though an example in which database 161A includes two data tables 168 and 169 is described above by way of example, the configuration of database 161A is not limited as such. The configuration of database 161A is not particularly limited so long as the database indicates which of the plurality of functions each of the plurality of functional materials 800 performs.

### I. Summary

As set forth above, server apparatus 100A in the present embodiment includes acceptance unit 153 that accepts an inquiry about rental of substrate 300 that supplies electric power to movable body 4 and functional material 800 that can each be layered on substrate 300. Each functional material 800 performs at least one function of a plurality of functions. The inquiry includes an instruction that designates the at least one function of the plurality of functions.

Server apparatus 100A further includes storage 160 in which database (association information) 161A in which function information is associated with identification information of each of a plurality of functional materials 800 is stored. The function information indicates which of the plurality of functions functional material 800 performs. Server apparatus 100A further includes specifying unit 154 that specifies at least one functional material 800 among the plurality of functional materials 800 based on the inquiry accepted by acceptance unit 153 and database 161A and output unit 199 that provides information based on a result of specifying by specifying unit 154.

According to such a configuration, server apparatus 100A can specify functional material 800 based on the inquiry, among the plurality of functional materials 800. Specifically, server apparatus 100A can specify functional material 800 that performs a function designated in the inquiry. Therefore, power feed mat 10A (specifically, a set of substrate 300 and functional material 800) can appropriately be rented to a user who has made the inquiry.

As in the first embodiment, one of the plurality of functions is the function to reduce occurrence of stress concentration in substrate 300, the waterproof function, the snow melting function, the function to radiate heat of substrate 300, the function to cut off electromagnetic waves to substrate 300, the representation function, or the function to communicate with movable body 4.

An information processing method includes accepting, by server apparatus (information processing apparatus) 100A, an inquiry about rental of substrate 300 that supplies electric power to movable body 4 and functional material 800 that can each be layered on substrate 300. Each functional material 800 performs one of a plurality of functions. The inquiry includes an instruction that designates at least one function of the plurality of functions. The information processing method further includes specifying, by server apparatus 100A, at least one functional material 800 among a plurality of functional materials 800 based on the accepted inquiry and database (association information) 161A in which function information is associated with identification information of each of the plurality of functional materials 800. The function information indicating which of the plurality of functions functional material 800 performs. The information processing method further includes providing, by server apparatus 100A, information based on a result of specifying.

According to such a configuration, server apparatus 100A can specify functional material 800 based on the inquiry, among the plurality of functional materials 800. Specifically, server apparatus 100A can specify functional material 800 that performs a function designated in the inquiry. Therefore, power feed mat 10A (specifically, a set of substrate 300 and functional material 800) can appropriately be rented to a user who has made the inquiry.

A program causes processor 101 of server apparatus 100A to perform accepting an inquiry about rental of a substrate that supplies electric power to movable body 4 and functional material 800 that can each be layered on substrate 300. Each functional material 800 performs one of a plurality of functions. The inquiry includes an instruction that designates at least one function of the plurality of functions.

The program further causes processor 101 to perform specifying at least one functional material 800 among a plurality of functional materials 800 based on the accepted inquiry and database (association information) 161A in which function information is associated with identification information of each of the plurality of functional materials 800. The function information indicating which of the plurality of functions functional material 800 performs. The program further causes processor 101 to perform providing information based on a result of specifying.

According to such a configuration, server apparatus 100A can specify functional material 800 based on the inquiry, among the plurality of functional materials 800. Specifically, server apparatus 100A can specify functional material 800 with a function designated in the inquiry. Therefore, power feed mat 10A (specifically, a set of substrate 300 and functional material 800) can appropriately be rented to a user who has made the inquiry.

### Modification

Though a configuration in which functional material 800 is layered on substrate 300 as shown in FIG. 15 is described above by way of example, the configuration is not limited thereto. Functional material 800 may be coupled along a plane (a direction perpendicular to the direction of layering) together with substrate 300. Specifically, a side surface portion of functional material 800 and a side surface portion of substrate 300 may be coupled to each other, side surface portions of functional materials 800 may be coupled to each other, or side surface portions of substrates 300 may be coupled to each other.

For example, functional material 800 (functional material 803 with the representation function) and substrate 300 may be laid on a road surface or the like so as not to be superimposed on each other. In this case, when movable body 4 is located above substrate 300, power is fed from substrate 300. A person who is in a vehicle representing a kind of movable body 4 can visually recognize various types of information owing to functional material 803.

A user who receives the rental service may use power feed mat 10A in which functional material 800 is layered on substrate 300, substrate 300 alone, and functional material 800 alone (including functional materials 800 layered on each other), in such a manner that they are juxtaposed on a road surface or the like as not being superimposed on one another. The user may use power feed mat 10A in which functional material 800 is layered on substrate 300 and functional material 800 alone (including functional materials 800 layered on each other), in such a manner that they are juxtaposed on a road surface or the like as not being superimposed on each other.

Information processing system 1000 may be configured such that server apparatus 100A accepts an inquiry (order) that designates the type of functional material 800. For example, information processing system 1000 may be configured such that server apparatus 100A accepts an order that indicates the type and the number of functional materials 800 and designates the number of substrates 300, such as ten functional materials with the representation function and thirty substrates 300.

Though embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. An information processing apparatus comprising:
acceptance means for accepting an inquiry about rental of a power feed mat that supplies electric power to a movable body, the power feed mat including a substrate including a power transmission coil and a functional body that performs at least one function of a plurality of functions, the functional body being provided at at least one of a position above and a position below the substrate, the inquiry including an instruction that designates the at least one function of the plurality of functions;
storage means in which association information in which function information is associated with identification information of each of a plurality of power feed mats is stored, the function information indicating which of the plurality of functions the power feed mat performs;
specifying means for specifying at least one power feed mat among the plurality of power feed mats based on the inquiry accepted by the acceptance means and the association information; and
output means for providing information based on a result of specifying by the specifying means.

2. An information processing apparatus comprising:
acceptance means for accepting an inquiry about rental of a substrate that supplies electric power to a movable body and a functional material that can each be layered on the substrate, each functional material performing at least one function of a plurality of functions, the inquiry including an instruction that designates the at least one function of the plurality of functions;
storage means in which association information in which function information is associated with identification information of each of a plurality of functional materials is stored, the function information indicating which of the plurality of functions the functional material performs;
specifying means for specifying at least one functional material among the plurality of functional materials based on the inquiry accepted by the acceptance means and the association information; and
output means for providing information based on a result of specifying by the specifying means.

3. The information processing apparatus according to claim 1, wherein
one of the plurality of functions is a function to reduce occurrence of stress concentration in the substrate, a waterproof function, or a snow melting function.

4. The information processing apparatus according to claim 2, wherein
one of the plurality of functions is a function to reduce occurrence of stress concentration in the substrate, a waterproof function, or a snow melting function.

5. The information processing apparatus according to claim 1, wherein
one of the plurality of functions is a function to radiate heat of the substrate or a function to cut off electromagnetic waves to the substrate.

6. The information processing apparatus according to claim 2, wherein
one of the plurality of functions is a function to radiate heat of the substrate or a function to cut off electromagnetic waves to the substrate.

7. The information processing apparatus according to claim 1, wherein
one of the plurality of functions is a representation function.

8. The information processing apparatus according to claim 2, wherein
one of the plurality of functions is a representation function.

9. The information processing apparatus according to claim 1, wherein
one of the plurality of functions is a function to communicate with the movable body.

10. The information processing apparatus according to claim 2, wherein
one of the plurality of functions is a function to communicate with the movable body.

11. The information processing apparatus according to claim 1, wherein
the substrate includes an antenna that communicates with the movable body.

12. The information processing apparatus according to claim 2, wherein
the substrate includes an antenna that communicates with the movable body.

13. The information processing apparatus according to claim 1, wherein
the acceptance means accepts the inquiry from a terminal device communicatively connected to the information processing apparatus, and
the output means notifies the terminal device of the result of specifying.

14. The information processing apparatus according to claim 2, wherein
the acceptance means accepts the inquiry from a terminal device communicatively connected to the information processing apparatus, and
the output means notifies the terminal device of the result of specifying.

15. An information processing system comprising:
the information processing apparatus according to claim 13; and
the terminal device.

16. An information processing system comprising:
the information processing apparatus according to claim 14; and
the terminal device.

17. An information processing method comprising:
accepting, by an information processing apparatus, an inquiry about rental of a power feed mat that supplies electric power to a movable body, the power feed mat including a substrate including a power transmission coil and a functional body that performs at least one function of a plurality of functions, the functional body being provided at at least one of a position above and a position below the substrate, the inquiry including an instruction that designates the at least one function of the plurality of functions;
specifying, by the information processing apparatus, at least one power feed mat among a plurality of power feed mats based on the accepted inquiry and association information in which function information is associated with identification information of each of the plurality of power feed mats, the function information indicating which of the plurality of functions the power feed mat performs; and
providing, by the information processing apparatus, information based on a result of specifying.

18. An information processing method comprising:
accepting, by an information processing apparatus, an inquiry about rental of a substrate that supplies electric power to a movable body and a functional material that can each be layered on the substrate, each functional material performing one of a plurality of functions, the inquiry including an instruction that designates at least one function of the plurality of functions;
specifying, by the information processing apparatus, at least one functional material among a plurality of functional materials based on the accepted inquiry and association information in which function information is associated with identification information of each of the plurality of functional materials, the function information indicating which of the plurality of functions the functional material performs; and
providing, by the information processing apparatus, information based on a result of specifying.
